(19) United States
(12) Patent Application Publication
(10) Pub. No.: US 2025/0180240 A1
(43) Pub. Date: Jun. 5, 2025

(54) ANOMALY DETECTION MODEL FOR AN AIR CONDITIONING SYSTEM AND METHODS OF GENERATING THE ANOMALY DETECTION MODEL

(71) Applicant: MUNTERS EUROPE AKTIEBOLAG, Kista (SE)

(72) Inventors: Amit Gitterman, Sandown, NH (US); Zeinab Moradi Nour, Stockholm (SE); Magnus Carlsson, Stockholm (SE)

(21) Appl. No.: 18/524,223

(22) Filed: Nov. 30, 2023

(51) Int. Cl. F24F 11/38; F24F 11/64; G06N 20/00

(52) U.S. Cl. CPC F24F 11/38; F24F 11/64; G06N 20/00

(57) ABSTRACT

An anomaly detection model for an air (fluid) conditioning unit or system, methods of detecting an anomaly using the anomaly detection model, and methods of generating the anomaly detection model. The air conditioning unit may include a plurality of sensors measuring operating conditions of the air conditioning unit to generate operating data. A computing device may be coupled to the air conditioning unit to receive the operating data and configured to execute the anomaly detection model to detect an anomaly in the air conditioning unit. The anomaly detection model may be an artificial-intelligence-based model, such as a machine-learning-based model. When the air conditioning unit is a dehumidifier, the anomaly detection model may determine a moisture mass balance between the process air and the reactivation air and determine, using an outlier detection method, if the moisture mass balance is an outlier.

### FIELD OF THE INVENTION

The invention relates to air conditioning systems, equipment, and methods, particularly rotary based sorbent conditioning systems, such as desiccant dehumidifiers.

### BACKGROUND OF THE INVENTION

Commercial and industrial scale air conditioning systems are used in a wide variety of applications. Some such air conditioning systems use a sorbent to remove various molecules from an airstream to condition the airstream. The sorbents may be arranged in a rotor to rotate between various zones, such as a process zone where the sorbent removes molecules from process air flowing through the sorbent in the process zone and a regeneration zone where a regeneration airstream removes the molecules from the sorbent to regenerate the sorbent. One example is dehumidification, where the sorbent is a desiccant and the desiccant is used to remove water, such as water vapor, from the process air.

### SUMMARY OF THE INVENTION

In one aspect, the invention relates to methods and systems for monitoring and/or controlling the operation of fluid (air) conditioning systems. Such monitoring may include utilizing anomaly detection model to detect anomalies in an air conditioning system including one or more operational air conditioning units. The anomaly detection model may include an artificial-intelligence-based model, such as a machine-learning-based model, or other multivariate anomaly detection models, including supervised or unsupervised models. These anomaly detection models may be used to provide predictive maintenance recommendations.

In another aspect, the invention relates to methods of generating an anomaly detection model for a fluid (air) conditioning system. The anomaly detection model may include an artificial-intelligence-based model, such as a machine-learning-based model, and generating the model may include training the artificial-intelligence-based model. The method may include obtaining data and labeling the data to train the model.

In a further aspect, the invention relates to a method of generating an anomaly detection model for an air conditioning system. The method includes receiving operating data, labeling anomalies within the operating data to generate labeled operating data, and training an artificial-intelligence-based model using the labeled operating data to generate the anomaly detection model. The operating data is received from a plurality of sensors located on an air conditioning unit. The plurality of sensors measures operating conditions of the air conditioning unit to generate the operating data. The operating data includes measured input data and measured output data corresponding to the measured input data. The anomalies are labeled within the operating data by applying a static filter to the operating data, applying a dynamic filter to the operating data, and labeling a potential anomaly as an anomaly when the dynamic filter identifies that the potential anomaly is not due to a variation in the measured input data. The static filter (i) determines an expected output based on the measured input data and (ii) identifies the potential anomaly when a difference between the expected output and the measured output data corresponding to the measured input data is greater than a predetermined amount. The dynamic filter applies a forecasting model to the measured input data to identify if the potential anomaly is due to a variation in the measured input data and/or the measured output data. The potential anomaly is labeled as an anomaly when the dynamic filter identifies that the potential anomaly is not due to a variation in the measured input data.

In yet another aspect, the invention relates to an air conditioning system including an operational air conditioning unit, a plurality of sensors located on the operational air conditioning unit, and a computing device. The plurality of sensors measures operating conditions of the operational air conditioning unit to generate operating data. The computing device is coupled to the operational air conditioning unit to receive the operating data and is configured to execute an anomaly detection model to detect an anomaly in the operational air conditioning unit.

These and other aspects of the invention will become apparent from the following disclosure.

### BRIEF DESCRIPTION OF THE DRAWINGS

FIG. 1 is a schematic diagram of an air conditioning system at a site.

FIG. 2 is a schematic view of a dehumidification system that may be used as an air conditioning unit of the air conditioning system shown in FIG. 1.

FIG. 3 is a schematic diagram of a plurality of air conditioning systems coupled to a computing device implementing an anomaly detection model.

FIG. 4 is a flow chart of a method of detecting an anomaly in the air conditioning system shown in FIGS. 1 and/or 3 using the anomaly detection model.

FIG. 5 is a flow chart of an anomaly detection model or process executed by a computing device in a step of the method shown in FIG. 4.

FIG. 6 illustrates a moisture mass balance determined using the process shown in FIG. 5.

FIG. 7 is a box plot representation of moisture mass balance calculations (over a specified time period) using the process shown in FIG. 5.

FIG. 8 is a flow chart illustrating a root cause process to identify needed preventive maintenance using the mass balance ratio process of FIG. 4.

FIG. 9 is a flow chart for generating another anomaly detection model that may be used in the process shown in FIG. 4.

FIG. 10 is a flow chart of a labeling process that may be used in a step of FIG. 9.

FIG. 11 is a schematic diagram and flow chart for utilizing and periodically retraining the anomaly detection model.

FIG. 12 is another schematic diagram and flow chart for utilizing and periodically retraining the anomaly detection model.

FIG. 13 is a schematic diagram of a computing device.

### DETAILED DESCRIPTION OF THE PREFERRED EMBODIMENTS

Fluid conditioning systems include one or more fluid conditioning units that are used to condition a fluid, such as air (i.e., an air conditioning system with one or more air conditioning units). In embodiments discussed herein, the fluid conditioned is air, but the disclosure may be applied to other fluid conditioning systems and fluid conditioning units. Air conditioning units, particularly those used in industrial/commercial applications, undergo periodic preventive maintenance, such as replacing filters, seals, drive belts, rollers, and the like. Current air conditioning unit maintenance relies on scheduled maintenance and/or is reactive in nature. A maintenance schedule or plan is developed based on the expected life and performance of individual components within the air conditioning system, and then maintenance is performed according to the plan. Such plans based on expected performance, however, may result in early replacement or unnecessary maintenance in units with components operating better than expected. Alternatively, such plans may result in late replacement in units with components operating worse than expected, reducing the operating efficiency of these air conditioning units. Such maintenance plans may also rely on human attentiveness to maintenance schedules and can lead to less than desirable performance or even premature component/subsystem failure if the maintenance schedule is not adhered to. In some instances, the maintenance is reactive, and the maintenance is performed only after a problem is identified, leading to additional downtime of the air conditioning unit.

Disclosed herein are different anomaly detection models and methods of generating these models. The models may be implemented for air conditioning systems and units to detect anomalies in operating air conditioning units and systems to identify changes in the operating performance of these units and systems, enabling predictive and/or real time maintenance.

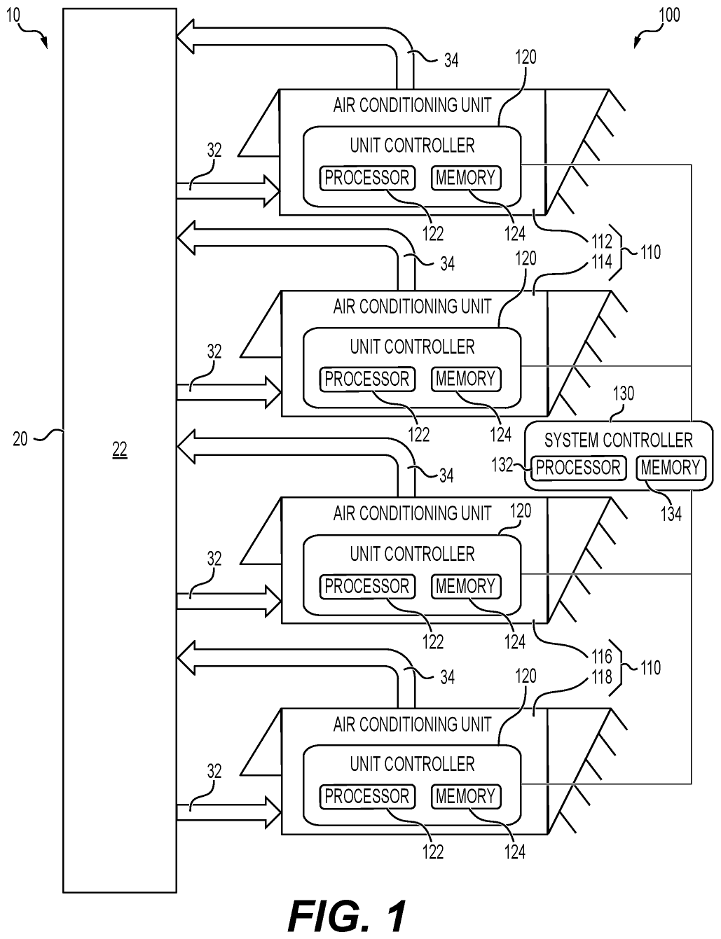

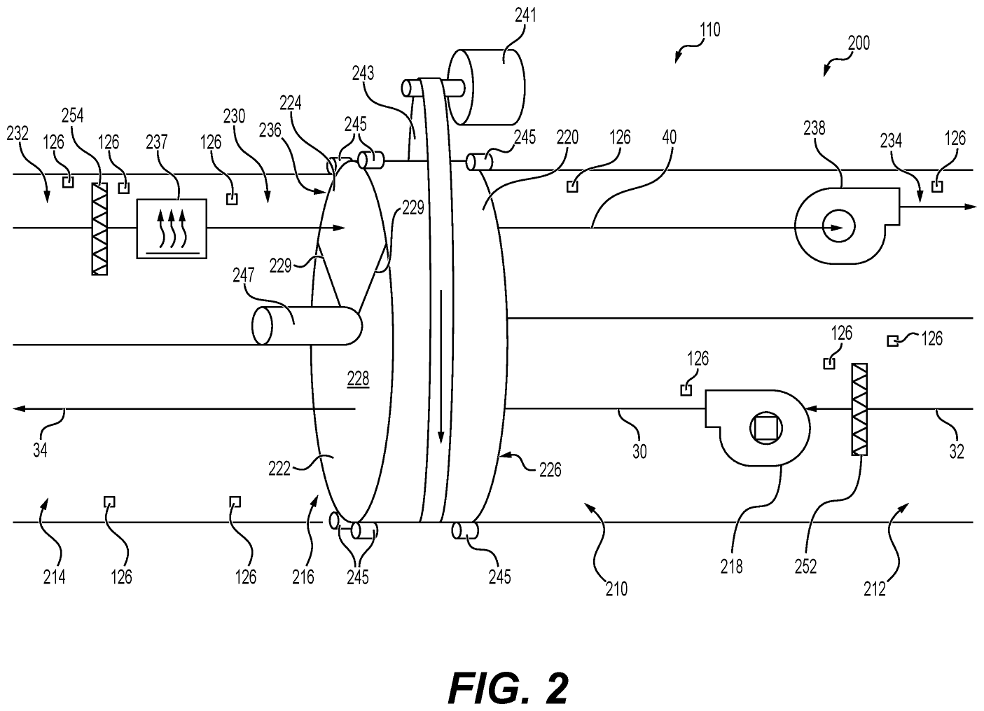

FIG. 1 is a schematic diagram of an air conditioning system 100 at a site 10. The air conditioning system 100 includes one or more air conditioning units 110, and in the embodiment shown in FIG. 1, the air conditioning system 100 includes a plurality of air conditioning units 110, including a first air conditioning unit 112, a second air conditioning unit 114, a third air conditioning unit 116, and a fourth air conditioning unit 118. Although four air conditioning units 110 are depicted in FIG. 1, the air conditioning unit 110 may have other numbers of air conditioning units 110. The air conditioning system 100 is used to condition air at the site 10, such as, for example, air within a building 20. Each air conditioning unit 110 may be fluidly connected to the building 20 to receive air from the building, condition the air, and return the air to the building. The air being conditioned by the air conditioning unit 110 is referred to herein as process air 30 (FIG. 2) and, in the depicted embodiment, includes return air 32 from the building 20 and supply air 34 being supplied to the building 20. Although depicted as a recirculating system, the air conditioning unit 110 may have other arrangements of the process air 30 including, for example, systems where ambient air is conditioned before being supplied to the building 20 as the supply air 34 or systems where the return air 32 is conditioned before being exhausted to the ambient environment.

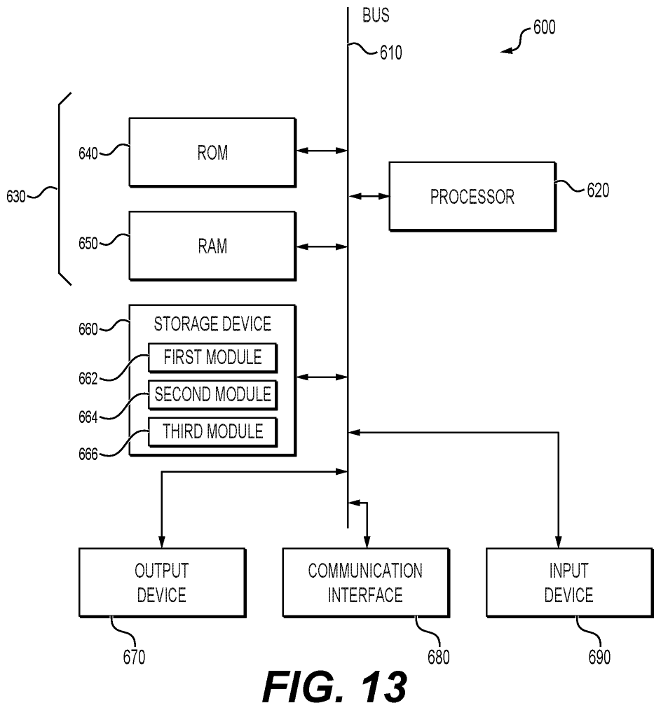

Each air conditioning unit 110 includes a unit controller 120 configured to operate the air conditioning unit 110. In particular, the unit controller 120 is communicatively coupled to sensors 126 (FIG. 2) within the air conditioning unit 110 to receive data about the operation of the air conditioning unit 110, as will be discussed further below. The unit controller 120 is also operatively coupled to the various components of the air conditioning unit 110 to operate the air conditioning unit 110 to provide supply air 34 at the desired operating conditions. In the depicted embodiment, the unit controller 120 is a microprocessor-based controller that includes a processor 122 for performing various functions discussed herein, and a memory 124 for storing various data. The unit controller 120 may be the computing device 600 shown and described below with reference to FIG. 13. The various methods discussed below may be implemented by way of a series of instructions stored in the memory 124 and executed by the processor 122.

The air conditioning system 100 also includes a system controller 130 that may be communicatively and operatively coupled to each of the air conditioning units 110 and, more specifically, the unit controller 120 of each air conditioning unit 110. The system controller 130 may also be a microprocessor-based controller that includes a processor 132 for performing various functions discussed herein, and a memory 134 for storing various data. The system controller 130 may be the computing device 600 shown and described below with reference to FIG. 13. The various methods discussed below may be implemented by way of a series of instructions stored in the memory 134 and executed by the processor 132.

As discussed further below, an anomaly detection model may be used to detect anomalies in the air conditioning system 100 and, more specifically, in one or more of the air conditioning units 110 of the air conditioning system 100. Preferably, the anomaly detection model may be used to detect anomalies to identify when preventive maintenance is needed. The anomaly detection models discussed herein may be used on various different air conditioning units, including, for example dehumidification units.

FIG. 2 is a schematic of a dehumidification unit 200 that may be used as each air conditioning unit 110 shown in FIG. 1. As noted above, although the air conditioning system 100 and the anomaly detection model are described with reference to the dehumidification units 200, the air conditioning unit 110 is not so limited and may be other air conditioning units. The dehumidification unit 200 may be used to condition air and, more specifically, dehumidify air. The air being dehumidified (conditioned) is referred to herein as process air 30, and the dehumidification system includes a process airflow. The dehumidification system then provides the conditioned (dehumidified) air, as supply air 34, to a space, such as a room 22 (FIG. 1) of the building 20 (FIG. 1). The air being conditioned (i.e., process air 30) may be drawn from various suitable sources including ambient air outside of the room or, as depicted in FIG. 1, recirculated air (e.g., return air 32) from within the room 22. The dehumidification unit 200 includes a process air plenum 210. The process air 30 enters the process air plenum 210 via a process air inlet 212, flows through the process air plenum 210 where it is dehumidified, and then flows out of the process air plenum 210 via a process air outlet 214.

The dehumidification unit 200 includes a desiccant rotor 220 containing a desiccant located therein. Suitable desiccants include, for example, titanium silicagel and lithium chloride. Such desiccants may be arranged in a porous structure through which air can flow. As shown in FIG. 2, the desiccant rotor 220 is a rotating Honeycombe® wheel, such as the desiccant wheel produced by Munters Corp. of Amesbury, Massachusetts, USA. In the desiccant wheel, the desiccant may be formed, for example, by being impregnated into a semi-ceramic honeycomb structure or other porous structure. The desiccant rotor 220, however, is not limited to such honeycomb structures, but includes other rotary desiccant systems where the desiccant may have other arrangements. For example, the desiccant may also be formed as granules or particulates and form a porous mass through which air can flow. Such granular desiccant may be formed in beds that are arranged horizontally or in multiple vertical beds.

A portion of the desiccant rotor 220 is located in the process air plenum 210 and positioned to allow the process air 30 to flow through the desiccant in the desiccant rotor 220 located within the process air plenum 210. The portion of the process air plenum 210 in which the desiccant is located is a sorption section 216 of the dehumidification unit 200, and the portion of the desiccant rotor 220 through which the process air 30 flows is referred to as the process segment 222 (or process zone) of the desiccant rotor 220. The process air 30 flows through the process segment 222 and moisture from the process air 30 is absorbed by the desiccant in the process segment 222, dehumidifying the process air 30. In the process segment 222 (the sorption section 216), the surface vapor pressure of the desiccant is lower than the process air 30, allowing the desiccant to absorb moisture from the process air 30.

As the desiccant absorbs moisture from the process air 30, the ability for the desiccant to absorb additional moisture is reduced, as the surface vapor pressure of the desiccant increases because of absorption. The desiccant is thus reactivated (regenerated) to restore its ability to absorb moisture. In this embodiment, the desiccant is reactivated using reactivation air 40 and the dehumidification system includes a reactivation airflow. The reactivation air 40 may be drawn from various suitable sources including ambient air. The dehumidification unit 200 includes a reactivation air plenum 230. The reactivation air 40 enters the reactivation air plenum 230 via a reactivation air inlet 232, flows through the reactivation air plenum 230 where the reactivation air 40 is used to reactivate the desiccant, and then flows out of the reactivation air plenum 230 via a reactivation air outlet 234. The portion of the desiccant rotor 220 through which the reactivation air 40 flows is referred to as the reactivation segment (or reactivation zone) 224 of the desiccant rotor 220. The reactivation air 40 flows through the reactivation segment 224 and removes moisture from the desiccant in the reactivation segment 224, reactivating (regenerating) the desiccant. The portion of the reactivation air plenum 230 in which the desiccant is located is a desorption section 236 of the dehumidification unit 200. Within the reactivation segment 224 (the desorption section 236), the desiccant has a surface vapor pressure that is significantly higher than the reactivation air 40, so moisture from the desiccant is transferred to the reactivation air 40 to equalize the pressure differential.

In this embodiment, the desiccant rotor 220 is rotatable to move the desiccant between the sorption section 216 and the desorption section 236. Various suitable mechanisms may be used to rotate the desiccant rotor 220. As shown in FIG. 2, for example, a motor 241 is drivingly coupled to the desiccant rotor 220 to transmit torque to the desiccant rotor 220 and rotate the desiccant rotor 220. The motor 241 may be coupled to the desiccant rotor 220 by various suitable means including, for example, by a belt 243. The motor 241 rotates the belt 243, which in turn rotates the desiccant rotor 220. The desiccant is fixed within the desiccant rotor 220 and rotates with the rotation of the desiccant rotor 220. The desiccant is thus a moveable desiccant that moves between the sorption section 216 and a desorption section 236 of the dehumidification unit 200. In embodiments using the desiccant rotor 220, the desiccant is exposed to a continuous repeating cycle of sorption and desorption to continuously dry the process air 30.

The desiccant rotor 220 may be rotatably supported by various suitable means. As shown in FIG. 1, for example, the desiccant rotor 220 may be supported by a plurality of rollers 245 abutting the outer circumferential surface of the desiccant rotor 220. Additionally or alternatively, the desiccant rotor 220 may include a shaft 247 (e.g., a central shaft) supported by bearings. In some embodiments, the motor 241 may rotate the shaft 247 to rotate the desiccant rotor 220.

The surface vapor pressure of the desiccant in the reactivation segment 224 (desorption section 236) should be higher than the vapor pressure of the reactivation air 40 to reactivate the desiccant. To increase the surface vapor pressure of the desiccant, the desiccant may be heated such as by using hot reactivation air 40. Accordingly, in some embodiments, the reactivation air 40 may be heated. Optionally, the dehumidification unit 200 may include a heater 237 located within the reactivation airflow, such as within the reactivation air plenum 230, upstream of the desiccant rotor 220 and, more specifically, upstream of the desorption section 236. Suitable heaters include, for example, a direct electrical heater (e.g., resistive heater), a gas-fired heater, and/or a heat-pump module.

The dehumidification unit 200 also includes a process blower 218. The process blower 218 is configured to produce a process airflow of the process air 30 within the dehumidification unit 200. In this embodiment, the process blower 218 is positioned upstream of the desiccant rotor 220 and, more specifically, upstream of the sorption section 216. Similarly, the dehumidification unit 200 may include a reactivation blower 238 to generate the reactivation airflow of the reactivation air 40. The reactivation blower 238 may be positioned downstream of the desiccant rotor 220 and, more specifically, downstream of the desorption section 236.

The desiccant rotor 220 includes a first face 226 and a second face 228. In the process segment 222, the first face 226 is an upstream face relative to the flow of the process air 30 and the second face 228 is a downstream face relative to the flow of the process air 30. In this embodiment, the process air 30 and the hot reactivation air 40 are arranged in a counter flow arrangement, and thus, in the reactivation segment 224, the first face 226 is a downstream face relative to the flow of the hot reactivation air 40 and the second face 228 is an upstream face relative to the flow of the hot reactivation air 40. The process segment 222 is separated from the reactivation segment 224 by at least one seal assembly 229. Each seal assembly 229 includes a seal, and seals include for example, face seals, such as elastomeric face seals. In this embodiment, the seals of the seal assemblies 229 are positioned to contact each of the first face 226 and the second face 228. Such face seals may have various suitable shapes including an O-shaped seals, D-shaped seals, and Ω-shaped seals. A seal as part of a seal assembly 229 may also be formed around the periphery of the desiccant rotor 220. In FIG. 2 the seal assemblies 229 are shown on the second face 228, but they may also be positioned in a similar arrangement on the first face 226.

The dehumidification unit 200 may also include one or more filters to filter and remove particulates from the air flowing through the dehumidification unit 200. Suitable filters include, for example, pleated minimum efficiency reporting value (MERV) rated filters. For example, a process air filter 252 is located within the process airflow of the process air 30, such as within the process air plenum 210 and, more specifically, within the process air inlet 212. As depicted in FIG. 2, the process air filter 252 is positioned upstream of the process blower 218 and the desiccant rotor 220 (more specifically, upstream of the sorption section 216). Similarly, a reactivation air filter 254 is located within the reactivation airflow of the reactivation air 40, such as within the reactivation air plenum 230 and, more specifically within the reactivation air inlet 232. As depicted in FIG. 2, the reactivation air filter 254 is positioned upstream of the heater 237, the desiccant rotor 220 (more specifically, upstream of the desorption section 236), and the reactivation blower 238.

The dehumidification unit 200 may have additional systems or components other than those specifically depicted in FIG. 2. As noted above, the desiccant rotor 220 may have a plurality of segments (or zones). The dehumidification unit 200 shown in FIG. 1 includes two segments (or zones)—a process segment 222 (or process zone) and a reactivation segment 224 (or reactivation zone)—but more than two segments may be used. For example, the dehumidification unit 200 may include a bypass regeneration system, and the desiccant rotor 220 includes a bypass segment (or bypass zone). A portion of the process air 30 (referred to herein as bypass air) flows through the bypass segment and moisture from the bypass air is absorbed by the desiccant in the bypass segment in a manner similar to the process segment 222 discussed above. The bypass air may be used as at least a portion of the reactivation air 40. Thus, instead of being directed to the process air outlet 214, the bypass air flows through a bypass plenum fluidly connecting the process air plenum 210 with the reactivation air plenum 230. A bypass damper may be used to control the flow of bypass air used as the reactivation air 40.

Additionally or alternatively, the dehumidification unit 200 may include a purge system (not shown), and the desiccant rotor 220 also may include a first isolation segment (first isolation zone) and a second isolation segment (second isolation zone) (also not shown). Isolation air is circulated in a closed loop, independent of the process air 30, the reactivation air 40, and the bypass air, between the desiccant in the first isolation segment and in the second isolation segment. An isolation blower circulates the isolation air. As discussed above, the reactivation air 40 heats the desiccant in the reactivation segment 224. The first isolation segment is positioned downstream of the reactivation segment 224 in the direction of rotation of the desiccant rotor 220, and, in this embodiment, adjacent to each of the reactivation segment 224 and the bypass segment. As the isolation air passes through the desiccant in the first isolation segment, the isolation air absorbs heat from the desiccant, cooling the desiccant before it enters the process segment 222 and heating the isolation air. The now heated isolation air is then circulated through the second isolation segment to preheat the desiccant in the second isolation segment. The second isolation segment is positioned upstream of the reactivation segment 224 in the direction of rotation of the desiccant rotor 220, and, in this embodiment, adjacent to each of the reactivation segment 224 and the process segment 222.

The dehumidification unit 200 may include still other systems. The dehumidification unit 200 may be used to further condition the process air 30 to desirable temperatures before exiting the dehumidification unit 200. The dehumidification unit 200 may, optionally, include one or both of a cooler or a heater. The cooler may be a cooling coil or other suitable cooling module positioned downstream of the desiccant rotor 220 and, more specifically the process segment 222 to cool the process air 30 after it is dehumidified. The cooling coil (cooler) may be part of a suitable cooling system such as a heat pump, direct expansion cooling system (refrigeration system), or chilled water system. Similarly, the heater may be a direct electrical heater (e.g., resistive heater), a gas-fired heater, and/or a heat-pump module.

As noted above, the dehumidification unit 200 includes a plurality of sensors 126. Various sensors may be used as the plurality of sensors 126 including, for example, temperature sensors, pressure sensors, humidity sensors (including relative humidity sensors), dew point sensors, enthalpy sensors, and sensors usable to calculate such values therefrom. Each of the sensors 126 may be located on the dehumidification unit 200. More specifically, individual sensors 126 may be positioned within the process airflow of the process air 30, such as within the process air plenum 210. These sensors 126 may be positioned upstream and downstream of the various components in the process airflow. As depicted in FIG. 2, for example, one sensor 126 is shown in the process air inlet 212 upstream of the process air filter 252, and another sensor 126 is shown downstream of the process air filter 252 and upstream of the process blower 218. Additional sensors 126 are positioned upstream and downstream of the desiccant rotor 220 and, more specifically, the process segment 222. A further sensor 126 is located in the process air outlet 214.

Similarly, individual sensors 126 may be positioned within the reactivation airflow of the reactivation air 40, such as within the reactivation air plenum 230. As depicted in FIG. 2, for example, one sensor 126 is shown in the reactivation air inlet 232 upstream of the reactivation air filter 254, and another sensor 126 is shown downstream of the reactivation air filter 254 and upstream of the heater 237. Additional sensors 126 are positioned upstream and downstream of the desiccant rotor 220 and, more specifically, the reactivation segment 224. A further sensor 126 is located in the reactivation air outlet 234, downstream of the reactivation blower 238.

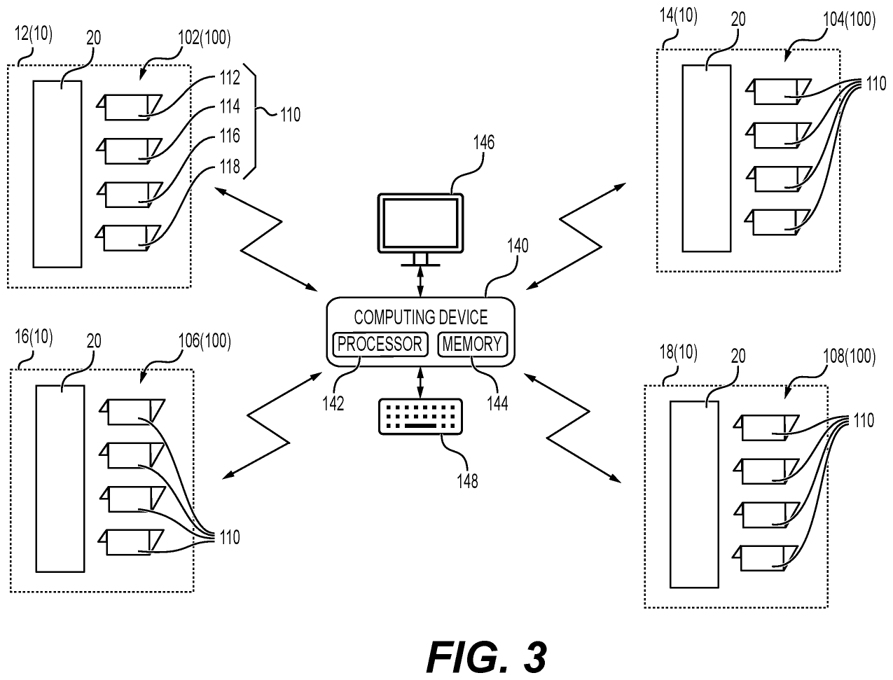

The plurality of sensors 126 are thus positioned and configured to measure operating conditions of the air conditioning unit 110, such as the dehumidification unit 200, and generate operating data. By positioning the sensors 126 upstream and downstream of the various components in the process airflow, the sensors 126 may be used to measure input data and measure output data, respectively, and the operating data may include the measured input data and the measured output data corresponding to the measured input data. As will be discussed further below, a computing device 140 (FIG. 3) is coupled to the air conditioning unit 110, such as the dehumidification unit 200, to receive the operating data, and the computing device 140 is configured to execute an anomaly detection model to detect an anomaly in the air conditioning system 100 (FIG. 1).

FIG. 3 is a schematic diagram of a plurality of air conditioning systems 100 coupled to a computing device 140 implementing an anomaly detection model. The computing device 140 may be a microprocessor-based controller that includes a processor 142 for performing various functions discussed herein, and a memory 144 for storing various data. The computing device 140 may be the computing device 600 shown and described below with reference to FIG. 13. The various methods discussed below may be implemented by way of a series of instructions stored in the memory 144 and executed by the processor 142. The computing device 140 may also include a display 146 coupled to the processor 142 and the processor 142 is configured to display various information thereon. In addition, the computing device 140 may include one or more user input devices 148, for the user to interact and operate the computing device 140. The user input devices 148 may include, for example, touch screens, buttons, keyboards, and mice, for example.

The anomaly detection model may be implemented locally relative to the air conditioning system 100. In some embodiments, the computing device 140 executing the anomaly detection model may be the unit controller 120 (FIG. 1) of each air conditioning unit 110 (FIG. 1) and/or the system controller 130 (FIG. 1). Other configurations, however, may be used. For example, in the embodiment depicted in FIG. 3 the computing device 140 is a remote computing device, such as a cloud-based computing device, communicatively coupled to one or more air conditioning systems 100. In the embodiment depicted in FIG. 3, the computing device 140 is connected to a plurality of air conditioning systems 100, including a first air conditioning system 102, a second air conditioning system 104, a third air conditioning system 106, and a fourth air conditioning system 108. More specifically, the system controller 130 of each of these air conditioning systems 100 may be coupled to the computing device 140 by a network or other suitable connection. When a network is used, the network may be a local area network (LAN), a wide area network (WAN), a public network, a private network, a proprietary network, a Public Switched Telephone Network (PSTN), the Internet, a wireless network, a virtual network, or any combination thereof. The network may also include various network access points, e.g., wired or wireless access points such as base stations or Internet exchange points, through which a data source may connect to the network in order to transmit information via the network.

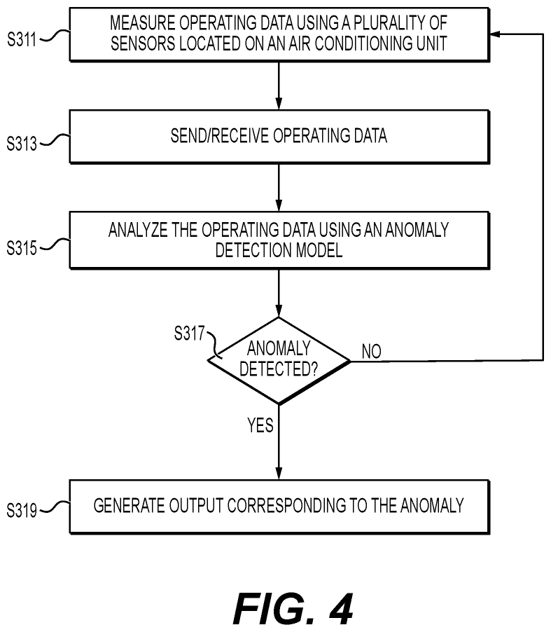

FIG. 4 is a flow chart of a method of detecting an anomaly in the air conditioning system 100 using the anomaly detection model. As discussed above, the sensors 126 are positioned on the air conditioning unit 110 to measure operating data of the air conditioning system 100 and, more specifically, the air conditioning units 110. The operating data may include measured input data and measured output data corresponding to the measured input data. The sensors 126 measure the operating data in step S311, and then in step S313, transmit (send) the operating data to the computing device 140. The computing device 140 also receives the operating data in step S313. The data may be sent and received in real time, but, particularly when the computing device 140 is a remote computing device, the operating data may be sent and received periodically or upon a request to transmit the operating data. The computing device 140 may thus be configured to request the operating data and, in response to the request, the unit controller 120 and/or the system controller 130 sends the operating data to the computing device 140. The operating data may be stored in one or more of the memories 124, 134, 144 discussed herein.

In step S315, the computing device 140 and, more specifically, the processor 142 executes the anomaly detection model to analyze the operating data for anomalies in step S315. This step may also include additional pre-processing or post-processing operations before or after the anomaly detection model is executed. Details of the anomaly detection model and the pre-processing or post-processing operations are discussed in more detail below.

Step S317 illustrates a decision point in the process. The decision point may be used when the anomalies are being detected in real time, but omitted in other instances when the analysis is performed periodically. If the analysis does not identify an anomaly (e.g., normal operating conditions), either no action is taken or, in a continuous process, the process returns to a previous step, such as step S311, and the sensors 126 continue measuring additional operating data. The analysis process, in step S317, is configured to detect at least one anomalous operating condition (or anomaly), and when the computing device 140 detects or identifies an anomalous operating condition, the process moves to step S319. When the computing device 140 identifies an anomaly, the computing device 140 in step S319 may generate an output corresponding to the anomaly, referred to herein as anomaly information, and transmit the output (anomaly information) to a communicatively coupled device, such as, for example, the display 146.

Example anomalous operating conditions of the desiccant rotor 220 include, for example, clogged or damaged filters (e.g., the process air filter 252 and/or the reactivation air filter 254); damaged or deteriorated seals, such as seals of the seal assemblies 229; a clogged, damaged or deteriorated desiccant rotor 220, a damaged fan or blower, such as the process blower 218 or the reactivation blower 238; or a damaged heater 237. Clogged or damaged filters result in the reduction of airflow of the process air 30 or reactivation air 40, for example. Damaged or deteriorated seals results in leakage. A clogged, damaged or deteriorated desiccant rotor 220 results in less dehumidification and reduction in flow of airflow of the process air 30 or reactivation air 40. A damaged fan or blower may also include fan/blower motor damage or deterioration, which results in reduction in airflow of the process air 30 or reactivation air 40. A damaged heater 237 results in less dehumidification and a reduction in system efficiency. The anomaly detection models discussed herein are particularly advantageous for detecting anomalous conditions prior to significant component or system failures and include off nominal conditions that, if not addressed, could lead to component or system failures. The wear, seal deterioration, clogging, or other particulate matter (dirt) damage, for example, detected by the anomaly detection models discussed herein allow for the air conditioning unit to be monitored and preventative maintenance performed based on actual operating conditions before component failures. Such anomaly information also allows for data-based decisions and cost benefit analysis to make determination on preventative maintenance.

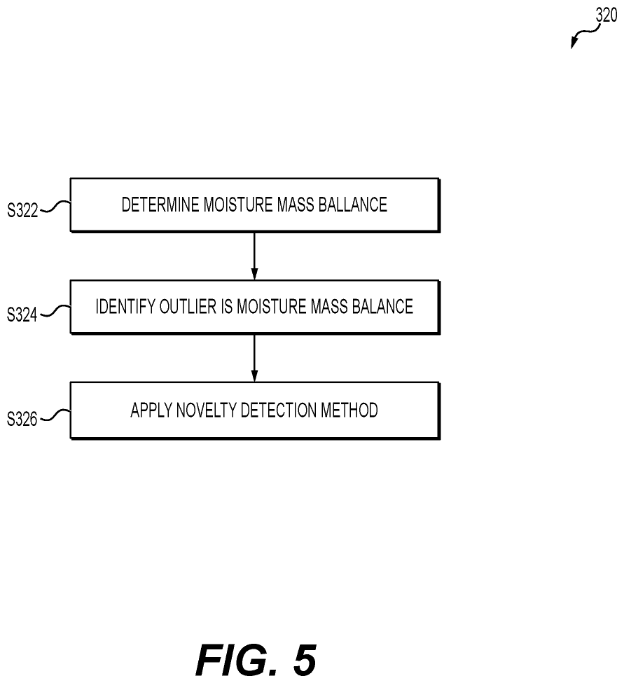

FIG. 5 is a flow chart of an anomaly detection model or process executed by the computing device 140 in step S315 of FIG. 4. For clarity with the other processes (models) discussed herein, the process shown in FIG. 5 is referred to as a mass balance ratio process 320. The mass balance ratio process 320 may be used when the air conditioning unit 110 is a dehumidification unit 200. As noted above, the dehumidification unit 200 includes a desiccant rotor 220 including a desiccant that moves between a process segment 222 (process zone) and a reactivation segment 224 (reactivation zone), and the sensors 126 may be positioned to measure values of each of the process air 30 and reactivation air 40. In step S322, the mass balance ratio process 320 includes determining a moisture mass balance between the process air 30 and the reactivation air 40 based on the measured values from the plurality of sensors 126. More specifically, the process may determine the moisture mass balance using the following expression (Expression 1):

$$\frac{MRC}{M R R} = \frac{( {\dot{m}}_{P} ) \times ( {M}_{P i} - {M}_{P o} )}{{\dot{m}}_{R} \times ( {M}_{R o} - {M}_{R i} )} \qquad ( 1 )$$

This moisture mass balance is a ratio of Moisture Removal Capacity (MRC) to Moisture Removal Rate (MRR). In Expression 1, \dot{m}_{P} is the airflow of the process air 30 at the process air outlet 214 in standard cubic feet per minute (SCFM), \dot{m}_{R} is the airflow of the reactivation air 40 at the reactivation air outlet 234 in SCFM, Mₚᵢ is the humidity ratio of the process air 30 at the process air inlet 212, M_{Po} is the humidity ratio of the process air 30 at the process air outlet 214, M_{Ri} is the humidity ratio of the reactivation air 40 at the reactivation air inlet 232, and M_{Ro} is the humidity ratio of the reactivation air 40 at the reactivation air outlet 234.

Alternatively, when the desiccant rotor 220 includes more than two zones, such as five zones as described above, for example, the process may determine the moisture mass balance using the following expression (Expression 2):

$$\frac{MRC}{M R R} = \frac{( {\dot{m}}_{P} ) \times ( {M}_{P i} - {M}_{P o} ) + ( {\dot{m}}_{R} ) \times ( {M}_{P i} - {M}_{R i} )}{{\dot{m}}_{R} \times ( {M}_{R o} - {M}_{R i} )} \qquad ( 2 )$$

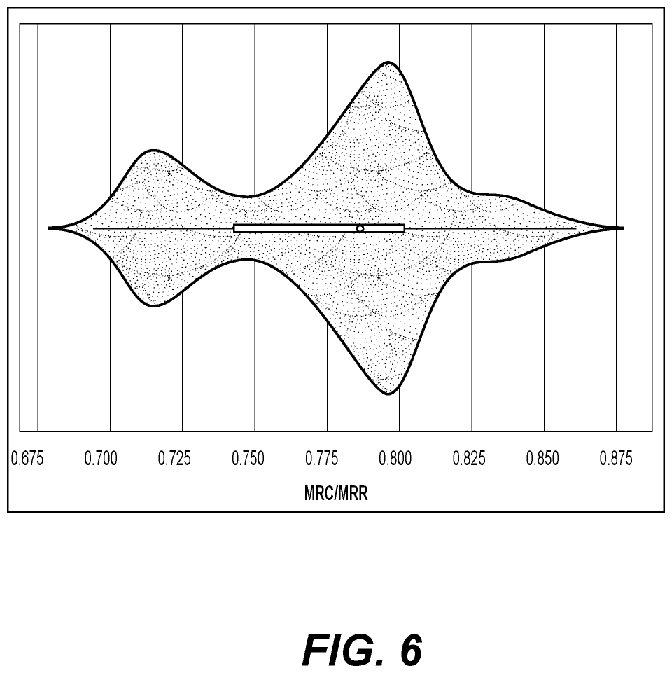

FIG. 6 is a violin plot of the a moisture mass balance determined using Expression 1 above, where the mass balance deviated below acceptable conditions.

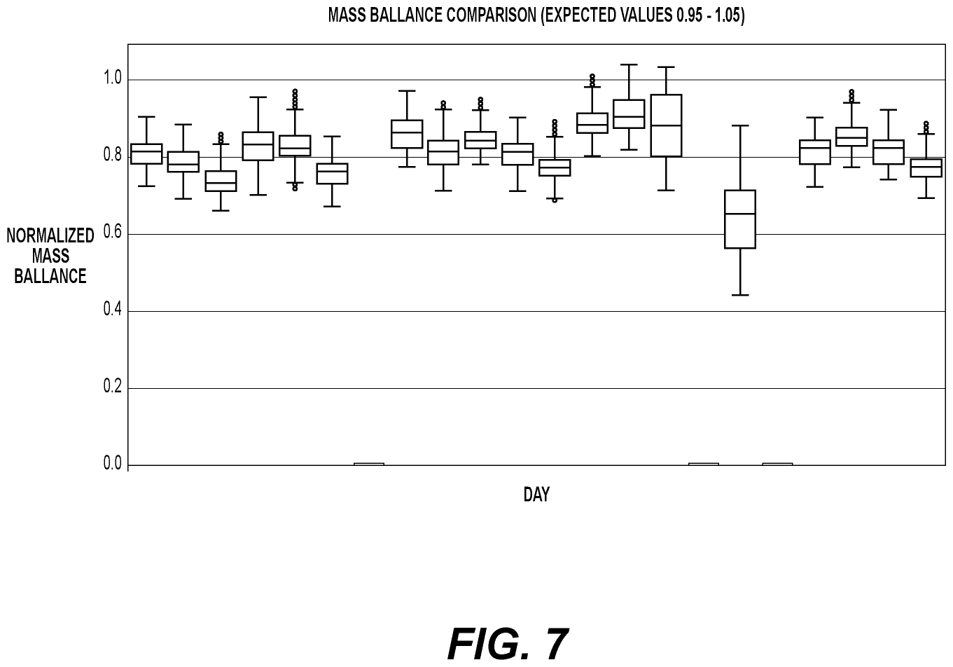

In the mass balance ratio process 320 shown in FIG. 5, the process proceeds to step S324 to determine if the moisture mass balance determined in step S322 is an outlier. Step S324 uses an outlier detection method, such as a univariate outlier detection method. Various outlier detection methods may be used and suitable methods include, for example, Tukey's method, median absolute deviation (MAD), Winsorizing, modified Z-score, M-estimators, and trimmed mean. Such methods may be employed over a defined time interval or period and one or more outliers may be determined over the time period. FIG. 7 is a box plot representation of moisture mass balance calculations (over a specified time period) while experiencing various specific inlet conditions for a dehumidification unit 200. Each box represents the moisture mass balance calculations for a day and are plotted for a period of several days. For the moisture mass balance determined using expression (1) or (2), an anomaly may be detected when the mass balance determined is outside preferred bounds. Such bounds may be, for example, from 0.95 to 1.05. In this example, an outlier, and thus an anomaly, is determined when the moisture mass balance is less than 0.95 or greater than 1.05.

In the mass balance ratio process 320 shown in FIG. 5, the process may proceed to step S326 to test confidence in the outlier (anomaly) detected in step S324. Step S326 is an optional step. In step S326, a novelty detection method will be applied to the mass balance data in step S324. The novelty detection method may be a machine-learning-based model employing, for example, a support vector machine (SVM), such as a one-class SVM. The machine learning process or machine-learning-based model may be, for example, an artificial neural network trained to identify the outliers. A database of mass balance calculations may be used to train the artificial neural network (a training database). The training database may thus include a plurality of mass balance calculations for different operating conditions and environments, including those discussed further below.

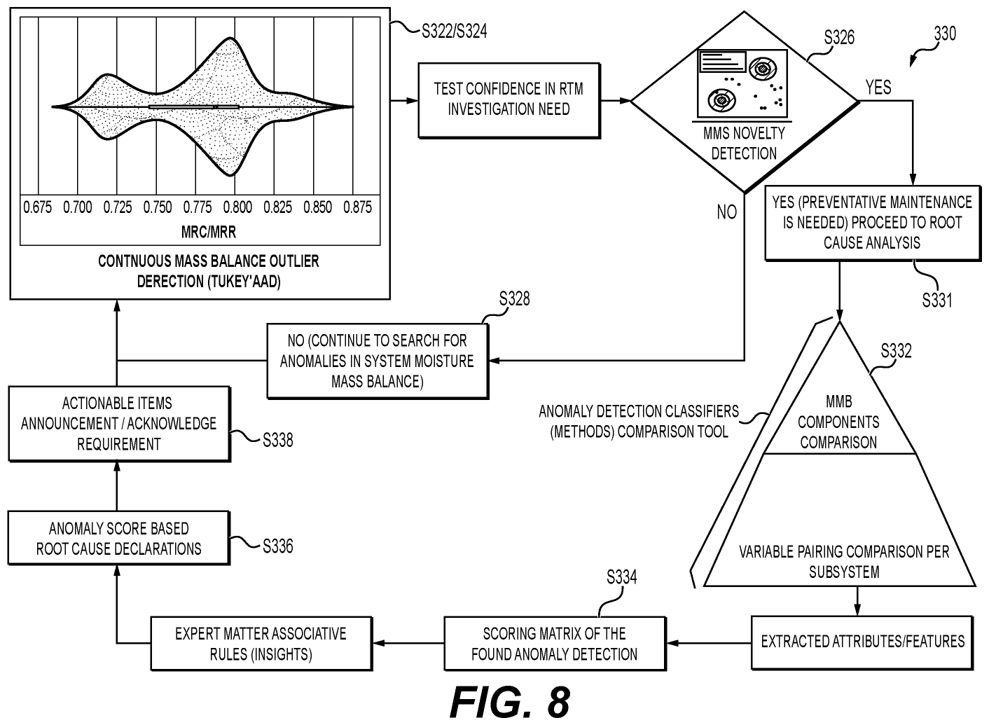

FIG. 8 is a flow chart illustrating a root cause process 330 to identify needed preventive maintenance using the mass balance ratio process 320 discussed above. The root cause process 330 may include the steps of the mass balance ratio process 320 discussed above. If, in step S326 an anomaly is detected, the method proceeds to step S331 and the root cause process 330 may be executed by the computing device 140 to determine the cause of the outlier and determine the preventive maintenance steps. If, in step S326 an anomaly is not detected, the method returns in step S324 to continue to monitor the dehumidification unit 200 for anomalies. n step S332, an anomaly detection classification process may be executed. This classification process may be executed using a machine learning based classification model. The machine learning based classification model may use various classification methods including, for example, high dimensional unsupervised multivariate anomaly detection. One or more of the following methods may be used: Mahalanobis distance (MCD), one-class SVM (OC-SVM) utilizing a radial basis function (RBF) kernel, isolation forests, or generative adversarial networks (GAN).

This classification process may begin by investigating if an anomaly or outlier is present in one or more of the factors of the moisture mass balance expression above, as represented by the MMB portion of the triangle in FIG. 8. Factors having an anomaly may be referred to herein as anomalous factors. When an anomaly or outlier is identified, the process continues branching out to identify potential anomalies, using the approaches discussed above, in the portions of the system (operating data) contributing to the anomalous factors. The operating data (e.g., measured data from the sensors 126 or values calculated therefrom) corresponding to individual portions of the system are referred to herein as system factors. The dehumidification unit 200 thus includes a plurality of system factors.

Preferably, the anomaly detection may be evaluated using pairs of system factors (i.e., two dimensions), but in other embodiments, higher dimension anomaly detection using more than two system factors may be considered. Each system factor will be considered a plurality of times, in different pairs of system variables, and a plurality of anomaly detection methods may be applied to each pair of system factors in parallel in order to gain anomaly confidence. From each pair of system factors, an anomaly score is determined. The anomaly score indicates the severity or degree of likelihood that the method has identified an anomaly.

In step S334, the anomaly scores are presented, such as in a matrix, for the various system factors (subsystems) of the dehumidification unit 200, and then the scores can be evaluated in step S336 to rank and select the most serious or relevant anomalous points. Various approaches may be used to rank and select these relevant anomalous points including the outlier degree of a pair of system factors defined, such as a receiver operating characteristic curve (ROC Curve). Step S336 may thus include ranking the system factors based on the anomaly scores. One or more of the system factors with the highest anomaly scores are selected and then then presented as actionable items or preventive maintenance in step S338, such as in the manner discussed with reference to step S319 of FIG. 4.

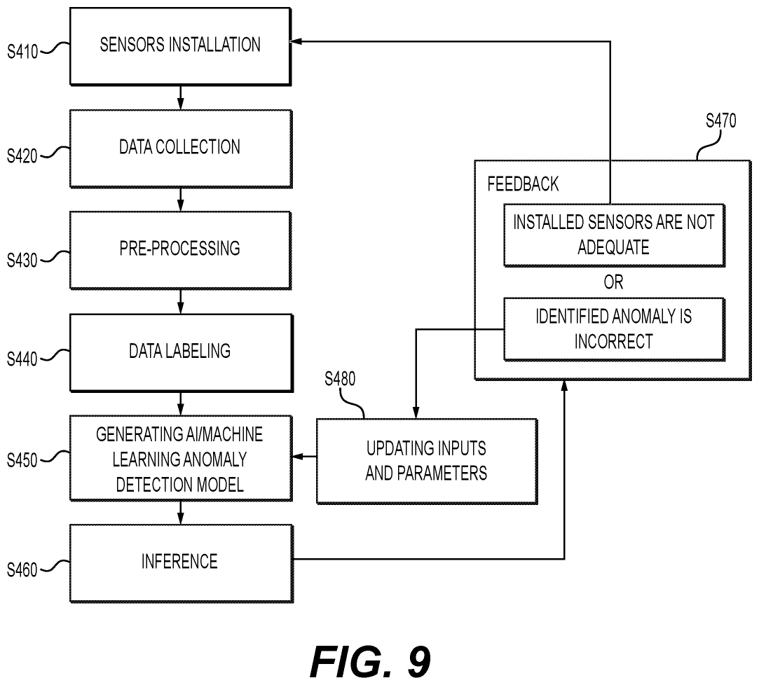

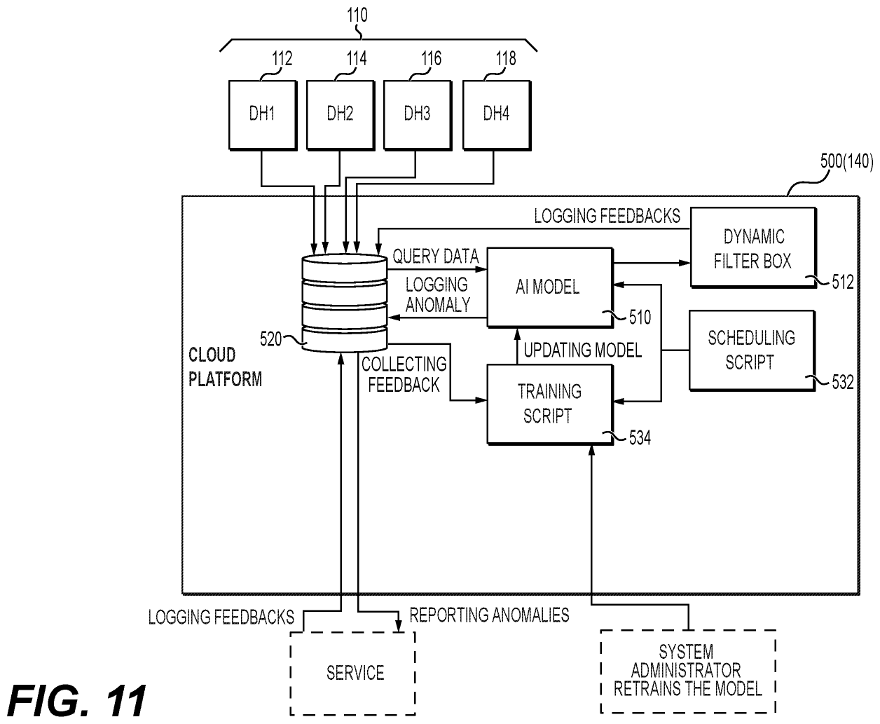

FIG. 9 is a flow chart for generating another anomaly detection model that may be used in the process shown in FIG. 4. The anomaly detection model developed in FIG. 9 is an artificial-intelligence- (AI-)based model 510 (FIG. 11) and, more specifically, a machine-learning- (ML-)based model. In step S410, one or more air conditioning systems 100 (FIG. 3) and, more specifically, the air conditioning units 110 (FIG. 3) thereof, are instrumented with a plurality of sensors 126 (FIG. 2). These sensors 126 may be those described above with reference to FIG. 2 and include the plurality of sensors 126 normally on the air conditioning unit 110 during operation. Additionally or alternatively, one or more air conditioning units 110 may be specially instrumented for developing the operating data used in the training data set (training database) for the purposes of training the AI-based model 510.

When developing the training data set, a plurality of different air conditioning units 110 are preferably used. As noted above and referring to FIG. 3, a plurality of air conditioning systems 100, including a first air conditioning system 102, a second air conditioning system 104, a third air conditioning system 106, and a fourth air conditioning system 108, may be used. Each of these systems may be located at different sites 10 including, a first site 12, a second site 14, a third site 16, and a fourth site 18. Each of these sites may be at different geographical locations. As used herein geographical locations are different when they are separated by 150 km or more. Preferably the geographical locations are in different climates using, for example, the Köppen Classification System and/or having different average seasonal atmospheric conditions. For example, the first site 12 may be located in a temperate climate (e.g., a warm summer continental climate), the second site 14 may be located in a tropical climate, the third site 16 may be located in a mild marine climate, and the fourth site 18 may be located in an arid climate. Accordingly, air conditioning units 110 located in different geographical locations and/or climates preferably are used to develop the training data set.

In addition, the air conditioning units 110 used to develop the training data set may also be operated at different operating conditions, such as substantially different operating conditions including a different quantified moisture load. Put another way, the application for the air conditioning units 110 may be different, such as serving a different purpose, running at different operating conditions, and the like. For example, one dehumidification unit 200 may be used as a bulk-humidity dryer, such as for outdoor air, and a second dehumidification unit 200 (or second desiccant rotor 220 within the first dehumidification unit 200) is a low-dew point dryer. In another example, the first air conditioning unit 112 may be for a first room and the second air conditioning unit 114 may be for a second room, each having different set points for the supply air 34 or different volumes. These air conditioning units 110 may be located on the same site 10 or different sites 10 (e.g., the first site 12 and the second site 14).

The air conditioning units 110 used to develop the training data set may also differ in other ways. For example, the first air conditioning unit 112 and the second air conditioning unit 114 may have different ages or service times. In another example, the first air conditioning unit 112 and the second air conditioning unit 114 are different models, similar models, or the same model. As used herein, similar models are models with the same product classification, but have some differences in the subsystems or major components, and in the same model those subsystems and major components are of the same type. For example, where the air conditioning unit 110 is the dehumidification unit 200, similar models may be different in rotor configuration, types of heaters, and subsystems used. In contrast, the dehumidification units that are of the same model are dehumidification units 200 with the same rotor configurations, types of heaters, and subsystems used. The previous examples refer to the air conditioning units 110 operating at the same site, but these criteria may also be applied to air conditioning units 110 operating at different sites.

In these previous examples, operating air conditioning units 110 may be used. As used herein operating air conditioning units 110 are those that are operating in the desired commercial or industrial application as opposed to a testing system. However, test or demonstration air conditioning units 110 may also be used to develop the training data set. Such systems may be preferably beneficial to develop controlled failures. For example, the method of generating the training data set may include provoking a failure in the air conditioning system 100 to produce an anomaly in the operating data associated with the failure. In some embodiments, a plurality of failures may be provoked at different times to produce an anomaly associated with each failure. Such failures may include, for example, imperfections (wear) in the desiccant rotor 220; reel imperfections (wear); vibrations, such as those in various fans or blowers (e.g., the process blower 218 or the reactivation blower 238) that might affect the air flows (instability); clogging (dirt) of filters, such as the process air filter 252 and the reactivation air filter 254; clogging of the desiccant rotor 220 (VOC's/organic impurities); and power failures from for example, dirt, instability, and the like.

In step S420, the operating data is collected and transmitted to/received by the computing device 140. The operating data may be pre-processed in step S430 to resolve issues with missing data, sensor problems, and the like. Then, the pre-processed operating data is labeled in step S440 to generate labeled operating data by labeling the pre-processed operating data corresponding to anomalies. The pre-processed operating data may be labeled through manual labelling, machine learning methods (e.g., neural network or time series data clustering), or by performing numerical decomposition methods on the pre-processed operating data.

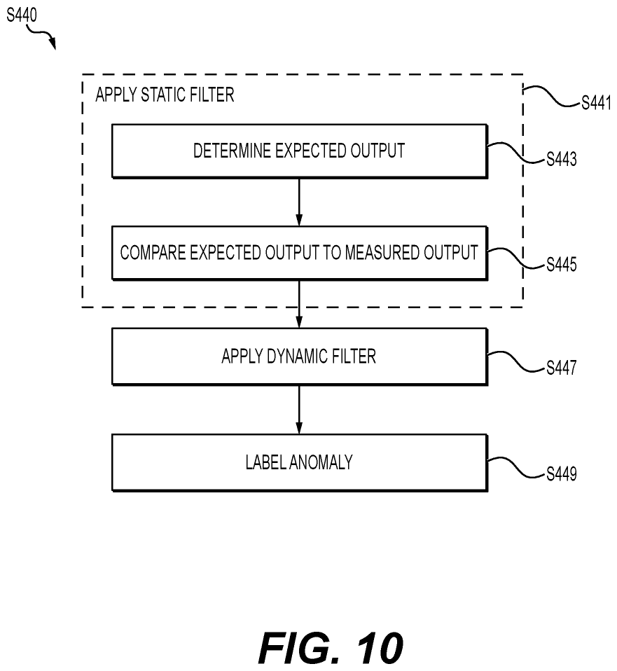

FIG. 10 is a flow chart of a labeling process that may be used in step S440 of FIG. 9 to label the pre-processed operating data. More specifically, this process may be used to label anomalies within the (pre-processed) operating data. In step S441, a static filter is applied to the operating data. As discussed above, the operating data may include measured input data and measured output data. The static filter determines an expected output based on the measure input data in step S443. The air conditioning unit 110 and, more specifically, the dehumidification unit 200 may be well understood in terms of the expected thermodynamic performance of the unit. Accordingly, a numerical or physically based model of the expected performance of the system may be applied to the measured input data to determine the expected output data. In step S445, the expected output data is compared to the measured output data and a potential anomaly is identified when a difference between the expected output data and the measured output data corresponding to the measured input data is different from a predetermined amount, such as, for example, greater than a predetermined amount or less than a predetermined amount.

In step S447, a dynamic filter is applied to the operating data. The dynamic filter may be a forecasting model (e.g., time series model) or a calculation toolbox that predicts the temporal changes in behavior of the system due to dynamic variations. The difference between expected output and the measured output may be due to changing dynamics in the environment in which the system is located. The dynamic filter is applied to the operating data to eliminate this ambiguity, allowing anomalies related to historical changes in the dynamic to be distinguished, identified and labeled. In step S449 the potential anomaly is labeled as an anomaly when the dynamic filter identifies that the potential anomaly is not due to a temporal variation in the measured input data.

Returning to FIG. 9, the labeled operating data is used to train the AI-based model in step S450. As noted above, the AI-based model 510 (FIG. 11) may be a ML-based model that may be trained using various methods including, for example, decision trees, support vector machines, Naïve Bayes classifier, k-means clustering, deep neural networks, sequential Bayesian filtering, or combinations thereof. The AI-based model 510 may be generated using supervised, unsupervised or semi-supervised learning algorithms. Reinforcement learning or deep reinforcement learning may be used, such as when the training database is a large data set. In Step S460, the AI-based model 510 draws an inference from the operating data and, in a supervised training, this inference maybe evaluated, such as feedback provided in step S470. In some instances, the inference may indicate that the sensors are not adequate to detect the performance of the air conditioning unit 110, and the sensors 126 may be changed, such as by adding sensors, adjusting the positioning of the sensors, and/or changing the type of sensors 126. Additionally or alternatively, the feedback provided in step S470 may include recognizing that the identified anomaly is incorrect. In such a case, this feedback is provided to the step of training the AI-based model 510 in step S450 and/or the data labeling of step S440 to correct incorrect identifications. As illustrated in FIG. 9, for example, the process may include a step (step S480) of updating inputs and parameters used to generate the AI-based model 510 in step S450.

FIG. 11 is a schematic diagram and flow chart for utilizing and periodically retraining the anomaly detection model. As noted above, the air conditioning units 110 are connected to a computing device 140 that implements the anomaly detection model, such as the AI-based model 510 discussed above. Although the AI-based model 510 is discussed in the depicted embodiment relative to FIG. 11, aspects discussed in this embodiment are applicable to other anomaly detection models. As depicted in FIG. 11, the computing device 140 is a cloud-based platform 500 with the AI-based model 510 implemented and stored thereon. As discussed above, the plurality of air conditioning units 110, such as the first air conditioning unit 112, the second air conditioning unit 114, the third air conditioning unit 116, and the fourth air conditioning unit 118, are connected to the cloud-based platform 500 and, more specifically, to a memory, such as a database memory 520. The operating data of from air conditioning units 110 are stored therein, and then, based on an instruction from a scheduling script 532, the AI-based model 510 analyzes the operating data stored in the database memory 520, and the feedbacks, such as anomalies and other inferences from the operational data, are stored in the database memory 520 to be reported, such as in step S319 (FIG. 4) discussed above.

As noted above, changes in the dynamics of the air conditioning unit 110 or the environment in which the air conditioning unit 110 is located may be characterized as anomalies by the AI-based model 510. The cloud-based platform 500 may also include a dynamic filter box 512 including the dynamic filter. The dynamic filter of the dynamic filter box 512) may be applied to potential anomalies identified by the AI-based model 510 and then anomalies remaining after applying the dynamic filter are logged as anomalies in the database memory 520.

The cloud-based platform 500 also includes a training script 534. The training script 534 may be used to periodically retrain the AI-based model 510 using the operational data anomalies identified in the operational data stored in the database memory 520. The training script 534 may retrain the AI-based model 510 in the manner as discussed above. The training script 534 may be executed in response to an instruction from the scheduling script 532 or an instruction from an operator, such as a system administrator.

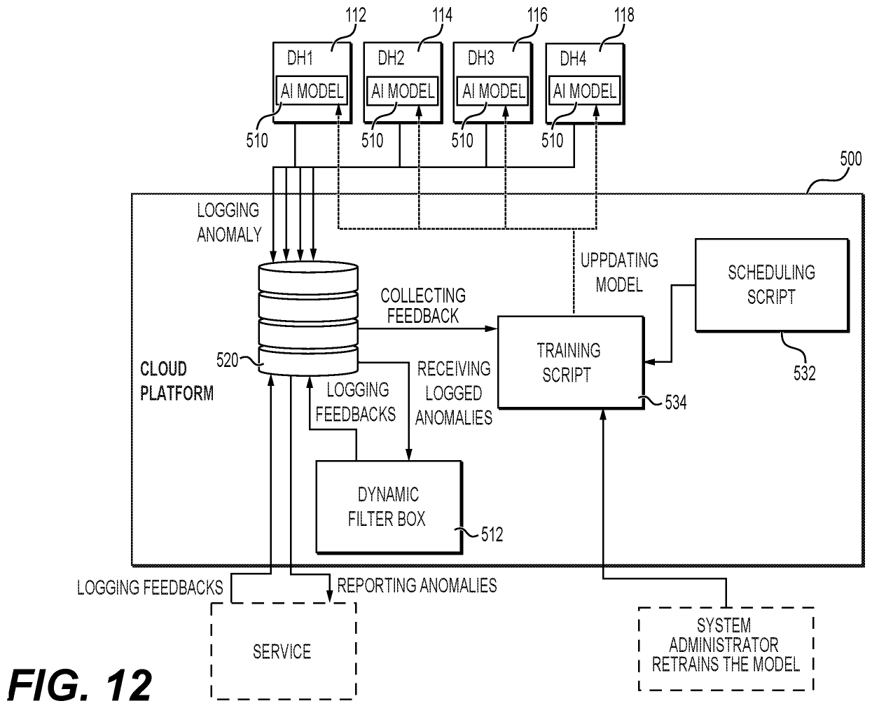

FIG. 12 is another schematic diagram and flow chart for utilizing and periodically retraining the anomaly detection model. The embodiment depicted in FIG. 12 is similar to the embodiment shown in FIG. 11 and the discussion of FIG. 11 also applies here. FIG. 11 may be used for real time or near real time monitoring of the air conditioning unit 110. It may be desirable, however, to limit how and when the air conditioning system 100 and air conditioning units 110 are connected to the computing device 140, particularly when the computing device 140 is the cloud-based platform 500. In such conditions, and as noted above, the AI-based model 510 may be implemented on each air conditioning system 100, such as on each air conditioning unit 110. The anomalies identified by the AI-based model 510 are transmitted to the database memory 520. As depicted in FIG. 11, the dynamic filter box 512 may be implemented on the cloud-based platform 500 instead of on each of the air conditioning units 110. The dynamic filter box 512 may be used to filter the anomalies identified by the AI-based model 510 before being reported, such as in step S319 (FIG. 4) discussed above.

Although FIG. 12 depicts the remote computing device as a cloud-based platform 500 and the data connection between the cloud-based platform 500 (remote computing device) and the air conditioning units 110 as a network, other configurations may be used. For example, some air conditioning units 110 may not have a network connection and there is not a possibility or option to connect the air conditioning unit 110 to a network. Alternatively, the air conditioning unit 110 may be disconnected from the network. In such a case, the operating data may be collected from the air conditioning unit 110 manually, such as by a technician connecting to the unit controller 120 or the system controller 130 with a local device. Similarly, an updated AI-based model 510 and/or training data to update the AI-based model 510 may be downloaded manually to the air conditioning unit 110. In such a case, the unit controller 120 and/or the system controller 130 may include the features shown on the cloud-based platform 500, such as the dynamic filter box 512 and/or the training script 534.

FIG. 13 shows a computing device 600 (system) that may be used as the unit controller 120, the system controller 130, the computing device 140, and/or the cloud-based platform 500 discussed herein. The computing device 600 shown in FIG. 13 includes a processing unit (CPU or processor) 620 and a system bus 610 that couples various system components including system memory 630, such as read-only memory (ROM) 640 and random-access memory (RAM) 650, to the processor 620. The computing device 600 can include a cache of high-speed memory connected directly with, in close proximity to, or integrated as part of the processor 620. The computing device 600 copies data from the system memory 630 and/or the storage device 660 to the cache for quick access by the processor 620. In this way, the cache provides a performance boost that avoids processor 620 delays while waiting for data. These and other modules can control or be configured to control the processor 620 to perform various actions. The system memory 630 can include multiple different types of memory with different performance characteristics. It can be appreciated that the disclosure may operate on a computing device 600 with more than one processor 620 or on a group or cluster of computing devices networked together to provide greater processing capability. The processor 620 can include any processor and a hardware module or software module, such as a first module 662, a second module 664, and a third module 666 stored in storage device 660, configured to control the processor 620, as well as a special-purpose processor where software instructions are incorporated into the actual processor design. The scripts, such as the scheduling script 532 and the training script 534, the AI-based model 510, and the dynamic filter box 512 are examples of modules. The processor 620 may essentially be a completely self-contained computing system, containing multiple cores or processors, a bus, memory controller, cache, etc. A multi-core processor may be symmetric or asymmetric.

The system bus 610 may be any of several types of bus structures, including a memory bus or memory controller, a peripheral bus, and a local bus using any of a variety of bus architectures. A basic input/output (BIOS) stored in ROM 640 or the like may provide the basic routine that helps to transfer information between elements within the computing device 600, such as during start-up. The computing device 600 further includes storage devices 660 such as a hard disk drive, a magnetic disk drive, an optical disk drive, a tape drive or the like. The storage device 660 can include software modules 662, 664, 666 for controlling the processor 620. Other hardware or software modules are contemplated. The storage device 660 is connected to the system bus 610 by a drive interface. The drives and the associated computer-readable storage media provide nonvolatile storage of computer-readable instructions, data structures, program modules, and other data for the computing device 600. In one aspect, a hardware module that performs a particular function includes the software component stored in a tangible computer-readable storage medium in connection with the necessary hardware components, such as the processor 620, the system bus 610, an output device 670, and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the computing device 600 is a small, handheld computing device, a desktop computer, or a computer server.

Although the exemplary embodiment described herein employs a hard disk as the storage device 660, other types of computer-readable media which can store data that are accessible by a computer, such as magnetic cassettes, flash memory cards, digital versatile disks, cartridges, random access memories (RAMs) 650, and read-only memories (ROMs) 640, may also be used in the exemplary operating environment. Tangible computer-readable storage media, computer-readable storage devices, or computer-readable memory devices expressly exclude media such as transitory waves, energy, carrier signals, electromagnetic waves, and signals per se.

To enable user interaction with the computing device 600, an input device 690 represents any number of input mechanisms, such as a microphone for speech, a touch-sensitive screen for gesture or graphical input, a keyboard, a mouse, and so forth. An output device 670 can also be one or more of a number of output devices including printers and displays (e.g., the display 146 discussed above). In some instances, multimodal systems enable a user to provide multiple types of input to communicate with the computing device 600. The communications interface 680 generally governs and manages the user input and system output, including the various communications interfaces discussed above. There is no restriction on operating on any particular hardware arrangement, and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

As used herein, the terms “upstream” and “downstream” are taken with respect to the flow of a fluid in a fluid pathway, such as, for example, the flow of process air in the dehumidification system.

Although this invention has been described with respect to certain specific exemplary embodiments, many additional modifications and variations will be apparent to those skilled in the art in light of this disclosure. It is, therefore, to be understood that this invention may be practiced otherwise than as specifically described. Thus, the exemplary embodiments of the invention should be considered in all respects to be illustrative and not restrictive, and the scope of the invention to be determined by any claims supportable by this application and the equivalents thereof, rather than by the foregoing description.

What is claimed is:

1. A method of generating an anomaly detection model for an air conditioning system, the method comprising:
receiving operating data from a plurality of sensors located in an air conditioning unit, the plurality of sensors measuring operating conditions of the air conditioning unit to generate the operating data, the operating data including measured input data and measured output data corresponding to the measured input data;
labeling anomalies within the operating data to generate labeled operating data by:
applying a static filter to the operating data, the static filter (i) determining an expected output based on the measured input data and (ii) identifying a potential anomaly when a difference between the expected output and the measured output data corresponding to the measured input data is greater than a predetermined amount;
applying a dynamic filter to the operating data, the dynamic filter applying a forecasting model to the measured input data to identify if the potential anomaly is due to a variation in the measured input data and/or the measured output data; and
labeling the potential anomaly as an anomaly when the dynamic filter identifies that the potential anomaly is not due to a variation in the measured input data; and
training an artificial-intelligence-based model using the labeled operating data to generate the anomaly detection model.

2. The method of claim 1, wherein the artificial-intelligence-based model is a machine-learning-based model.

3. The method of claim 1, wherein the air conditioning unit is one air conditioning unit of a plurality of air conditioning units and the operating data includes measurements from a plurality of sensors located on each air conditioning unit.

4. The method of claim 3, wherein the plurality of air conditioning units includes a first air conditioning unit and a second air conditioning unit older than the first air conditioning unit.

5. The method of claim 3, wherein the first air conditioning unit and the second air conditioning unit each operate at the same geographical location.

6. The method of claim 3, wherein the plurality of air conditioning units includes a first air conditioning unit and a second air conditioning unit operating at a different geographical location than the first air conditioning unit.

7. The method of claim 3, wherein the first air conditioning unit and the second air conditioning are similar models.

8. The method of claim 3, wherein the first air conditioning unit and the second air conditioning are the same model.

9. The method of claim 1, wherein the air conditioning unit is a dehumidifier.

10. The method of claim 9, wherein the dehumidifier includes a rotary desiccant wheel.

11. The method of claim 1, further comprising provoking a failure in the air conditioning unit to produce an anomaly associated with the failure.

12. The method of claim 1, further comprising provoking, at different times, a plurality of failures in the air conditioning unit to produce an anomaly associated with each failure.

13. A method of detecting an anomaly in an air conditioning system including an operational air conditioning unit, the method comprising:
receiving operating data from a plurality of sensors located in the operational air conditioning unit, the plurality of sensors measuring operating conditions of the operational air conditioning unit to generate the operating data; and
using the anomaly detection model generated using the method of claim 1 to analyze the operating data of the operational air conditioning unit and identify an operational anomaly.

14. The method of claim 13, further comprising:
evaluating the operational anomaly to identify if the anomaly is an actual anomaly or a false anomaly; and
labeling the operating data corresponding to the operational anomaly with the outcome of the evaluation and updating the labeled operating data.

15. The method of claim 14, further comprising periodically retraining the artificial-intelligence-based model using the updated labeled operating data.

16. An air conditioning system comprising:
an operational air conditioning unit,
a plurality of sensors located in the operational air conditioning unit, the plurality of sensors measuring operating conditions of the operational air conditioning unit to generate operating data; and
a computing device coupled to the operational air conditioning unit to receive the operating data and being configured to execute an anomaly detection model to detect an anomaly in the operational air conditioning unit.

17. The air conditioning system of claim 16, wherein the anomaly detection model is an artificial-intelligence-based model.

18. The air conditioning system of claim 17, wherein the artificial-intelligence-based model is a machine-learning-based model.

19. The air conditioning system of claim 17, wherein the artificial-intelligence-based model has been trained using a training database including labeled operating data, the labeled operating data having been generated by labeling anomalies within training operating data from a plurality of sensors located on a training air conditioning unit, the plurality of sensors measuring operating conditions of the training air conditioning unit to generate the training operating data, the training operating data including measured input data and measured output data corresponding to the measured input data, and
wherein labeling anomalies within the training operating data include:
applying a static filter to the training operating data, the static filter (i) determining expected output based on the measured input data and (ii) identifying a potential anomaly when a difference between the expected output and the measured output data corresponding to the measured input data is greater than a predetermined amount;
applying a dynamic filter to the operating data, the dynamic filter applying a forecasting model to the measured input data to identify if the potential anomaly is due to a variation in the measured input data and/or measured output data; and
labeling the potential anomaly as an anomaly when the dynamic filter identifies that the potential anomaly is not due to a variation in the measured input data and/or measured output data.

20. The air conditioning system of claim 16, wherein the operational air conditioning unit is a dehumidifier for dehumidifying process air, the dehumidifier including a desiccant wheel moveable between a process zone and a reactivation zone, in operation, the process air flowing through the desiccant in the process zone and the desiccant absorbing or adsorbing moisture from the process air, reactivation air flowing through the desiccant in the reactivation zone and absorbing or adsorbing moisture from the desiccant, and the plurality of sensors located on the operational air conditioning unit being positioned to measure values of the process air and the reactivation air.

21. The air conditioning system of claim 20, wherein the anomaly detection model, when executed by the computing device, includes:
determining a moisture mass balance between the process air and the reactivation air based on the measured values from the plurality of sensors;
determining, using an outlier detection method, if the moisture mass balance is an outlier; and
identifying the anomaly when the moisture mass balance is an outlier.

22. The air conditioning system of claim 21, wherein the operating data includes system factors, and wherein the anomaly detection model, when executed by the computing device, further includes, when the moisture mass balance is an outlier:
determining a plurality of anomaly scores for the air conditioning unit, each anomaly score of the plurality of anomaly scores being based on a comparison between of a plurality of the system factors;
ranking the system factors based on the plurality of anomaly scores; and
selecting one or more of the system factors with the highest anomaly scores as the anomaly detected by the anomaly detection model.
